(19) United States
(12) Patent Application Publication
(10) Pub. No.: US 2022/0343249 A1
(43) Pub. Date: Oct. 27, 2022

(54) SYSTEMS AND PROCESSES FOR ITERATIVELY TRAINING A RENUMERATION TRAINING MODULE

(71) Applicant: Job Market Maker, LLC, Charleston, SC (US)

(72) Inventors: Christina R. Petrosso, Folly Beach, SC (US); Joseph W. Hanna, Charleston, SC (US); Diego Valdes, Gainesville, FL (US); David Trachtenberg, Charleston, SC (US)

(73) Assignee: Job Market Maker, LLC, Charleston, SC (US)

(21) Appl. No.: 17/729,898

(22) Filed: Apr. 26, 2022

Related U.S. Application Data
(60) Provisional application No. 63/179,839, filed on Apr. 26, 2021.

(51) Int. Cl. G06Q 10/06; G06Q 10/10; G06K 9/62; G06F 16/23

(52) U.S. Cl. CPC G06Q 10/06315; G06Q 10/1053; G06K 9/6256; G06F 16/2386

(57) ABSTRACT

Systems and processes for iteratively training a training module are described herein. In various embodiments, the process includes: (1) retrieving bulk data comprising a plurality of raw position data elements from a plurality of data sources, (2) transforming the raw position data elements according to preconfigured classification guidelines to generate standardized position data element groups; (3) training a raw training module by iteratively processing each of the standardized position data element groups through a raw training module to generate respective output renumeration values; (4) updating one or more emphasis guidelines based on a comparison of the respective output renumeration values; (5) processing an input position data element set with a trained training module to generate a display renumeration value; and (6) modifying a display based on the display renumeration value.

### CROSS-REFERENCE TO RELATED APPLICATIONS

This application claims the benefit of and priority to U.S. Patent Application No. 63/179,839 filed Apr. 26, 2021, entitled “RATE OPTIMIZATION MACHINE LEARNING SYSTEMS AND PROCESSES,” which is incorporated herein by reference in its entirety.

### BACKGROUND

Present computing systems for calculating potential renumeration packages are typically limited to generic, average, and potentially regional information sets. Existing systems lack the ability to extract and transform raw information sets into an individualized communication for optimized renumeration based on a variety of tunable guidelines and position-specific factors.

### BRIEF SUMMARY OF THE DISCLOSURE

Briefly described, and according to one embodiment, aspects of the present disclosure generally relate to systems and processes for iteratively training a training module for processing and transforming raw data elements from a plurality of data sources. In various embodiments, the disclosed process and system retrieves data from a plurality of data sources and then uses processes for iteratively training a training module to transform the data and arrive at calculated renumerations based on one or more tunable emphasis guidelines.

In various embodiments, the present system may implement various training modules and data transformation processes to produce a dynamic data analytics system. In at least one embodiment, the output of the system may include, but is not limited to, a calculated renumeration for a specific information set based on a variety of tunable emphasis guidelines.

In at least one embodiment, the system is configured to automatically (or in response to an input) collect, retrieve, or access data from a plurality of data sources. In some embodiments, the plurality of data sources can include a large number of sources including at least 40,000 sources. In various embodiments, the system is configured to automatically analyze and index accessible sources to obtain position data, applicant data, geographic data, and/or other information. In one or more embodiments, the system is configured to automatically access and process bulk data and/or other information stored in one or more databases operatively connected to the training module system. In various embodiments, the system retrieves data by processing electronic documents, web pages, and other digital media. In some embodiments, the system processes individual data, position descriptions, reviews, and other digital media to obtain seeker, position, location data, and/or other information.

In at least one embodiment, the system may include data from a plurality of sources for creating a taxonomy. In certain embodiments, the system may include one or more algorithms to automatically update and train the taxonomy. For example, in some embodiments, data corresponding to the categories in the taxonomy can be processed with the one or more algorithms to generate a plurality of emphasis guidelines. In various embodiments, the system may include an interface for operating and controlling the various facets of the taxonomy and training system as described herein.

In one or more embodiments, the present system may transform the data from the plurality of data sources for analysis via the training module processes and other techniques described herein. In at least one embodiment, the present system may clean and transform data to remove, impute, or otherwise modify missing, null, or erroneous data values. In various embodiments, the present system may remove identifying information in order to anonymize and remove any correlated data. Similarly, the system may index and correlate specific data elements to facilitate the training module training process.

In one or more embodiments, the present system may include one or more processes for training a renumeration recommendation training module. In various embodiments, the present system may iteratively retrieve, transform, and update training modules in order to compare input data elements with preconfigured threshold renumeration values associated with a known position.

According to a first aspect, the present disclosure includes a process for iteratively training a training module, the process comprising: retrieving bulk data from a plurality of data sources, the bulk data comprising a plurality of grouped data entries that each include a respective known renumeration value and a respective plurality of raw position data elements; transforming the respective plurality of raw position data elements in each of the plurality of grouped data entries according to preconfigured classification guidelines to generate a plurality of standardized position data element groups; extracting the respective known renumeration value from each of the plurality of grouped data entries; linking the known renumeration value extracted from each of the plurality of grouped data entries with a corresponding one of the plurality of standardized position data element groups; training a raw training module by: processing each of the plurality of standardized position data element groups through the raw training module to generate a respective output renumeration value; comparing the respective output renumeration value output from each of the plurality of standardized position data element groups with the known renumeration value associated therewith; and updating one or more raw emphasis guidelines for a first plurality of nodes of the raw training module based on results of the comparing step; generating a trained training module by iteratively repeating the training of the raw training module until the results of the comparing step indicate that the respective output renumeration value output from each of the plurality of standardized position data element groups is within a threshold amount of the known renumeration value associated therewith; receiving an input position data element set; processing the input position data element set with the trained training module to generate a display renumeration value; and modifying a display based on the display renumeration value.

In a second aspect, the process for iteratively training the training module of the first aspect or any other aspect further comprising: extracting one or more trained emphasis guidelines for a second plurality of nodes of the trained training module; and modifying the display to include the one or more trained emphasis guidelines along with the display renumeration value.

In a third aspect, the process for iteratively training the training module of the first aspect or any other aspect further comprising: retrieving updated bulk data from the plurality of data sources, the updated bulk data comprising an updated plurality of grouped data entries that each include a respective updated known renumeration value and a respective updated plurality of raw position data elements; transforming the respective updated plurality of raw position data elements in each of the updated plurality of grouped data entries according to the preconfigured classification guidelines to generate an updated plurality of standardized position data element groups; extracting the respective updated known renumeration value from each of the updated plurality of grouped data entries; linking the updated known renumeration value extracted from each of the updated plurality of grouped data entries with a corresponding one of the updated plurality of standardized position data element groups; retraining the trained training module by iteratively: processing each of the updated plurality of standardized position data element groups through the trained training module to generate the respective output renumeration value; comparing the respective output renumeration value output from each of the updated plurality of standardized position data element groups with the updated known renumeration value associated therewith; and updating one or more trained emphasis guidelines for a second plurality of nodes of the trained training module based on results of the comparing step.

In a fourth aspect, the process for iteratively training the training module of the first aspect or any other aspect further comprising: retrieving the bulk data from the plurality of data sources by retrieving proprietary bulk data from proprietary ones of the plurality of data sources and non-proprietary bulk data from non-proprietary ones of the plurality of data sources.

In a fifth aspect, the process for iteratively training the training module of the first aspect or any other aspect further comprising: after modifying the display, receiving changes to the input position data element set; processing the changes to the input position data element set with the trained training module to generate an updated display renumeration value; and modifying the display based on the updated display renumeration value.

In a sixth aspect, the process for iteratively training the training module of the first aspect or any other aspect wherein each element in each one of the plurality of standardized position data element groups corresponds to one of the first plurality of nodes of the of the raw training module.

In a seventh aspect, the process for iteratively training the training module of the first aspect or any other aspect wherein one element in each one of the plurality of standardized position data element groups includes a location element.

In an eighth aspect, the process for iteratively training the training module of the first aspect or any other aspect wherein one element in each one of the plurality of standardized position data element groups includes a related entity element.

In a ninth aspect, the process for iteratively training the training module of the first aspect or any other aspect further comprising: in response to generating the display renumeration value, extracting one or more trained emphasis guidelines for a second plurality of nodes of the trained training module; and generating a graphical user interface display that includes the display renumeration value and the one or more trained emphasis guidelines for the second plurality of nodes in relation to corresponding ones of the input position data element set.

In a tenth aspect, the process for iteratively training the training module of the ninth aspect or any other aspect further comprising: receiving user input via the graphical user interface display modifying the input position data element set; processing the input position data element set as modified with the trained training module to generate an updated display renumeration value; and generating the updated display renumeration value on the graphical user interface display.

According to an eleventh aspect, the present disclosure includes a system for iteratively training a training module, the system comprising: at least one memory unit, at least one processor in communication with the at least one memory unit and at least one database, the at least one processor is configured to: retrieve bulk data from the at least one database; process the bulk data by categorizing a plurality of grouped data entries that each include a respective known renumeration value and a respective plurality of raw position data elements; transform the respective plurality of raw position data elements in each of the plurality of grouped data entries according to preconfigured classification guidelines to generate a plurality of standardized position data element groups; extract the respective known renumeration value from each of the plurality of grouped data entries; save the known renumeration value extracted from each of the plurality of grouped data entries in the at least one memory unit; link the known renumeration value saved in the at least one memory unit with a corresponding one of the plurality of standardized position data element groups; execute a raw training module by: processing each of the plurality of standardized position data element groups through the raw training module to generate a respective output renumeration value; storing the respective output renumeration value in the at least one memory unit; comparing the respective output renumeration value saved in the at least one memory unit with the known renumeration value saved in the at least one memory unit and associated therewith; updating one or more raw emphasis guidelines for a first plurality of nodes of the raw training module based on results of the comparing; and storing the updated one or more raw emphasis guidelines in the at least one memory unit; generate a trained training module by iteratively repeating the execution of the raw training module until the results of the comparing step indicate that the respective output renumeration value saved in the at least one memory unit is within a threshold amount of the known renumeration value saved in the at least one memory unit and associated therewith; receive an input position data element set; process the input position data element set with the trained training module to generate a display renumeration value; and modify a display based on the display renumeration value.

According to a twelfth aspect, the system for iteratively training the training module of the eleventh aspect or any other aspect, the at least one processor further configured to: extract one or more trained emphasis guidelines for a second plurality of nodes of the trained training module; and modify the display to include the one or more trained emphasis guidelines along with the display renumeration value.

According to a thirteenth aspect, the system for iteratively training the training module of the eleventh aspect or any other aspect, the at least one processor further configured to: retrieve updated bulk data from the at least one database; process the updated bulk data by categorizing an updated plurality of grouped data entries that each include a respective updated known renumeration value and a respective updated plurality of raw position data elements; transform the respective updated plurality of raw position data elements in each of the updated plurality of grouped data entries according to the preconfigured classification guidelines to generate an updated plurality of standardized position data element groups; extract the respective updated known renumeration value from each of the updated plurality of grouped data entries; save the updated known renumeration value extracted from each of the plurality of grouped data entries in the at least one memory unit; link the updated known renumeration value saved in at least one memory unit extracted with a corresponding one of the updated plurality of standardized position data element groups; retrain the trained training module by iteratively: processing each of the updated plurality of standardized position data element groups through the trained training module to generate the respective output renumeration value; storing the respective output renumeration value in the at least one memory units; comparing the respective output renumeration value saved in the at least one memory unit with the updated plurality of standardized position data element groups associated therewith; updating one or more trained emphasis guidelines for a second plurality of nodes of the trained training module based on results of the comparing; and storing the updated one or more trained emphasis guidelines in the at least one memory unit.

According to a fourteenth aspect, the system for iteratively training the training module of the eleventh aspect or any other aspect, wherein the at least one database includes at least one proprietary data source and at least one non-proprietary data source, and wherein the at least one processor is further configured to: retrieve proprietary segments of the bulk data from the at least one proprietary data source; and retrieve non-proprietary segments of the bulk data from the at least one non-proprietary data source.

According to a fifteenth aspect, the system for iteratively training the training module of the eleventh aspect or any other aspect, the at least on processor further configured to: after modifying the display, receive changes to the input position data element set; process the changes to the input position data element set with the trained training module to generate an updated display renumeration value; save the updated display renumeration value in the at least one memory unit; and modify the display based on the updated display renumeration value.

According to a sixteenth aspect, the system for iteratively training the training module of the eleventh aspect or any other aspect, wherein each element in each one of the plurality of standardized position data element groups corresponds to one of the first plurality of nodes of the of the raw training module.

According to a seventeenth aspect, the system for iteratively training the training module of the eleventh aspect or any other aspect, wherein one element in each one of the plurality of standardized position data element groups includes a location element.

According to an eighteenth aspect, the system for iteratively training the training module of the eleventh aspect or any other aspect, wherein one element in each one of the plurality of standardized position data element groups includes a related entity element.

According to a nineteenth aspect, the system for iteratively training the training module of the eleventh aspect or any other aspect, the at least on processor further configured to: in response to generating the display renumeration value, extract one or more trained emphasis guidelines for a second plurality of nodes of the trained training module and generate a graphical user interface display for rendering, wherein the graphical user interface display includes the display renumeration value and the one or more trained emphasis guidelines for the second plurality of nodes in relation to corresponding ones of the input position data element set.

According to a twentieth aspect, the system for iteratively training the training module of the nineteenth aspect or any other aspect, the at least on processor further configured to: receive a user input via the graphical user interface display; update the input position data element set according to the user input; process the input position data element set as updated with the trained training module to generate an updated display renumeration value; save the updated display renumeration value in the at least one memory unit; and generate an updated graphical user interface display for rendering, wherein the updated graphical user interface display includes the updated display renumeration value.

These and other aspects, features, and benefits of the systems and processes described herein will become apparent from the following detailed written description taken in conjunction with the following drawings, although variations and modifications thereto may be affected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a flow diagram of a process for iteratively training a training module according to embodiments of the present disclosure.

FIG. 2 is a flow diagram of a process for iteratively training a raw training module according to embodiments of the present disclosure.

FIG. 3 is a flow diagram of a process for iteratively training a raw training module according to embodiments of the present disclosure.

FIG. 4 is a block diagram of a system for iteratively training a training module according to embodiments of the present disclosure.

FIG. 5 illustrates a graphical interface display showing a position summary according to embodiments of the present disclosure.

FIG. 6 illustrates a graphical interface display showing a position summary comparison according to embodiments of the present disclosure.

FIG. 7 illustrates a graphical interface display showing an emphasis guideline visualization according to embodiments of the present disclosure.

While the disclosure is susceptible to various modifications and alternative forms, specific embodiments thereof are shown by way of example in the drawings and will herein be described in detail. It should be understood, however, that the drawings and detailed description presented herein are not intended to limit the disclosure to the particular embodiment disclosed, but on the contrary, the intention is to cover all modifications, equivalents, and alternatives falling within the spirit and scope of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Overview

In various embodiments, aspects of the present disclosure generally relate to systems and processes for iteratively training a training module for providing customized renumeration communications by processing and transforming raw data elements from a plurality of data sources. The system may then use an iteratively trained training module that can be updated and retrained based on updates to bulk data received from a plurality of data sources to provide an updated display renumeration based on personalized context and intelligence of the training module. Rather than using standard averages based on generic regional data, the system uses a processor to transform data retrieved from a plurality of data sources to generate a training module that outputs a customized renumeration as determined by a plurality of emphasis guidelines that can be updated based on position-specific data elements.

### DESCRIPTION OF THE FIGURES

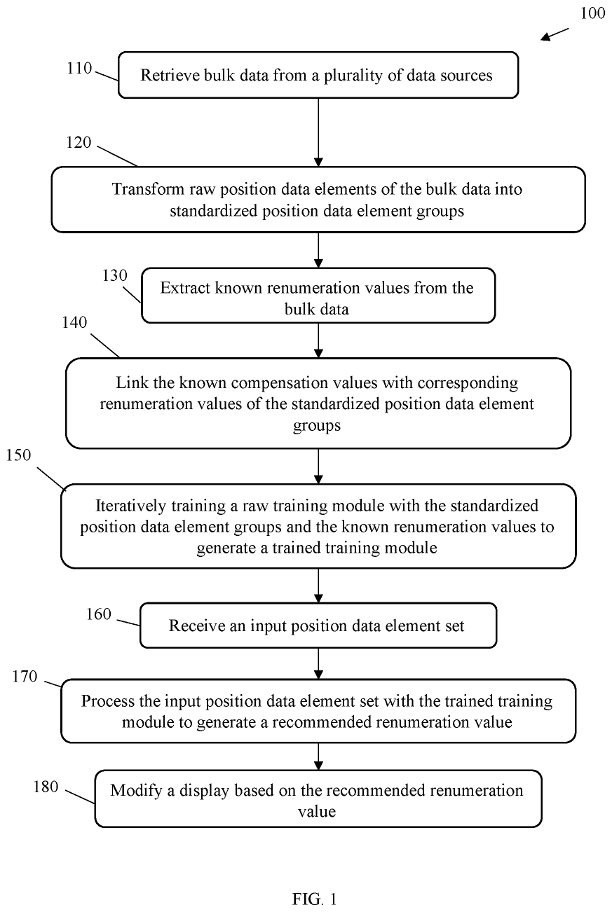

Referring now to the figures, for the purposes of example and explanation of the fundamental processes and components of the disclosed systems and processes, reference is made to FIG. 1, which illustrates a training process 100 for iteratively training a training module to provide renumeration communications, according to embodiments of the present disclosure. As one skilled in the art will understand and appreciate, the training process 100 shown in FIG. 1 (and those of all other flowcharts and sequence diagrams shown and described herein) represents merely one approach or embodiment of the present system, and other aspects are used according to various embodiments of the present system. The steps and processes may operate concurrently and continuously and are generally asynchronous, independent, and are not necessarily performed in the order shown.

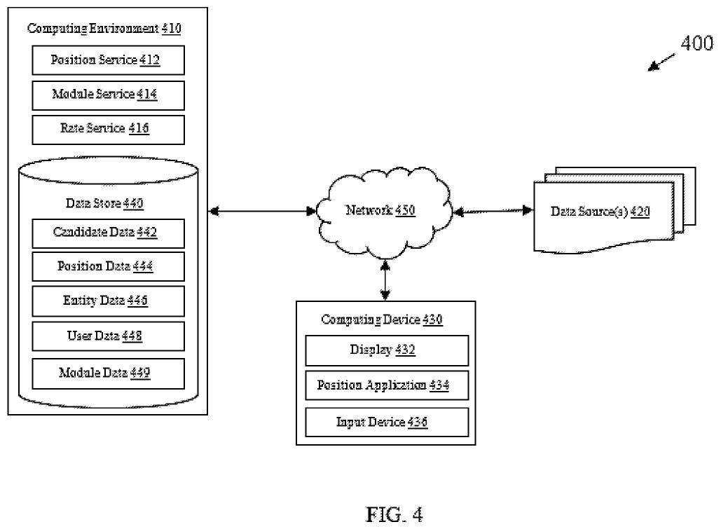

At step 110, the system retrieves bulk data from a plurality of data sources. In certain embodiments, the plurality of data sources may include either or both of proprietary and non-proprietary data sources. In at least one embodiment, the present system may automatically or manually (e.g., in response to input) collect, retrieve, or access data including, but not limited to, candidate data 442, position data 444, entity data 446, user data 448, or module data 449 (see FIG. 4). In one or more embodiments, the system may collect data by a plurality of methods including, but not limited to, initiating requests at data sources (e.g., via an application programming interface (“API”)), scraping and indexing webpages and other information sources, retrieving data from a data store, and receiving and processing inputs or other uploaded information (e.g., such as an uploaded offer letter, position offer, job posting, advertisement, etc.). In one example, to collect position data, the system receives and processes a set of inputs and uploads from a particular user account with which an entity is associated. In at least one embodiment, the system receives or retrieves the bulk data from multiple data sources, including but not limited to: U.S. Bureau of Labor Statistics (“BLS”) surveys, job postings, position descriptions, network surveys, anonymized customer data, data partners, social and public networks, as well as collects data directly from websites through, for example, web scraping technology. In certain embodiments, this data may be received as a file, through an API call, scraped directly, or via other mechanisms. Once collected, the bulk data may be then stored in one or more databases or a data lake.

According to various aspects of the present disclosure, the data may then be processed, cleaned, mapped, triangulated, and validated across the various data sources. In one embodiment, the system includes a first Adaptive Taxonomy℠ called the “IQ Rate Optimizer” and uses over 40,000 proprietary and public data sources to create an evergreen, adaptive taxonomy, which provides real-time skill mapping. In at least one embodiment, the system syncs entity-specific taxonomy to the most up-to-date position titles and critical skills via an AI-powered database. In at least this way, the entity-specific data collected by the system can be tagged based on a plurality of raw data elements so that the data can be further processed and analyzed to provide customized renumeration recommendations, according to the systems and processes described below.

The collected bulk data can include a plurality of grouped data entries. In some embodiments, the grouped data entries may include a plurality of raw data elements associated with a specific position, person, entity, or other similar correlation point. The plurality of raw data elements may include, but is not limited to, entity data, position data, rate data, and candidate data. When used throughout the present disclosure, one skilled in the art will understand that “entity” can include a company, organization, or similar. When used throughout the present disclosure, one skilled in the art will understand that “position” can include a role, job, or similar and can refer to part-time, full-time, contract, or other types of arrangements. When used throughout the present disclosure, one skilled in the art will understand that “candidate” can include a current or targeted employee, applicant, contractor, authorized agent, or an individual generally associated with a position.

In at least one embodiment, the system receives or retrieves bulk data including entity data 446 (see FIG. 4), which may include but is not limited to: 1) industry; 2) type, such as public, private, government, academic, etc.; 3) size, including, but is not limited to, number of positions; 4) age; and 5) one or more brand metrics.

In some embodiments, the system receives or retrieves bulk data including position data 444 (see FIG. 4), which can include but is not limited to: 1) position title; 2) position level, including, but not limited to, experience level, and education level; 3) position functions; 4) similar open positions; and 5) open growth opportunities.

According to particular embodiments, the system receives or retrieves candidate data 442 (see FIG. 4), which can include, but is not limited to: 1) current tenure; 2) average tenure in previous positions; 3) number of previous roles with current entity; 4) number of previous positions with previous entities; 5) skills; 6) education level; 7) relative rate; 8) previous industries; 9) previous entity size, including, but not limited to, and number of positions; 10) previous entity age; 11) geography (e.g., candidate location, current entity location, previous entity location, etc.); and 12) commute time.

In some embodiments, the grouped data entries may also include a known rate value. When used throughout the present disclosure, one skilled in the art will understand that “rate” and “renumeration” can include salary, pay, compensation, benefits, or a combination of these.

In at least one embodiment, the system can calculate one or more secondary metrics from the collected data. For example, the system can compute, for each position, an estimated rate demand. To determine an estimated rate demand, the system can utilize collected data including, but not limited to: 1) position title; 2) position level; 3) statistical data describing actual rates of various people having various position titles; 4) skills; 5) relative rate; 6) education level; 7) geography; and 8) commute time. The system utilizes the processes illustrated in FIGS. 1-3 and described below to transform the collected data into customized rate demand based, in part, on entity-specific taxonomy. In one embodiment, the entity-specific taxonomy includes real-time skill market mapping based on an entity's specific roles and the most in-demand skills for those roles. The training module utilizes a series of emphasis guidelines to further process and filter the demand rate based on different position levels, associated skills, and known compensation values within the entity, along with other factors, to provide an estimated rate demand.

Referring back to FIG. 1, at step 120, that the system transforms the raw data elements, including a plurality of raw position data elements into standardized position data element groups. When used throughout the present disclosure, one skilled in the art will understand that “transform” can include normalize, standardize, and other advanced analysis techniques for manipulating the data such that it can be processes, analyzed, and used to generate customized recommendation outputs according to the present disclosure. In at least one embodiment, the data transformation can include one or more data modifications such as: 1) imputing missing data; 2) converting data to one or more formats (e.g., for example, converting string data to numeric data); 3) removing extra characters; 4) formatting data to a specific case (e.g., for example, converting all uppercase characters to lowercase characters); 5) normalizing data formats; and 6) anonymizing data elements.

In various embodiments, the system may also perform position resolution on the collected data (e.g., prior to, or after, other data processing and transformation steps). In these embodiments (and others), the raw position data elements are transformed into standardized position data element groups. To transform the raw position data elements into standardized position data element groups, the system may assign classifications using a series of preconfigured keywords and metrics commonly found in the plurality of data sources to generate groups of standardized data element groups that can be further analyzed and processed during the iterative training of step 150 described below.

In at least one embodiment, the system evaluates completeness of collected data. For example, the system may determine a magnitude of missing data in a collected dataset, and based on the magnitude, can calculate a “completeness” score. The system can include a “completeness” threshold and can compare completeness scores to the completeness threshold. In one or more embodiments, if the system determines that a dataset's completeness score does not satisfy a completeness threshold, the system can exclude the dataset from further evaluation. By evaluating and filtering for completeness, the system may exclude datasets that are intolerably data deficient (e.g., and which may deleteriously impact further analytical processes).

At step 130, the system extracts the known renumeration values from the bulk data. The extraction may be performed through one or more data processing techniques, including but not limited to, performing text recognition, data transformation, text mining, and information extraction. In one embodiment, the system may use data processing and extraction techniques described at step 254 of U.S. patent application Ser. No. 17/063,263 filed Oct. 5, 2020, entitled “MACHINE LEARNING SYSTEMS AND METHODS FOR PREDICTIVE ENGAGEMENT,” (“the '263 application”), which is incorporated herein by reference in its entirety.

In step 140, the system links the extracted known renumeration values from step 130 with corresponding renumeration values of the standardized position data element groups. In at least this way, the known renumeration values are associated with standardized position data element groups that are based on position-specific elements and extracted values may further be linked to a plurality of position-specific elements. In at least one embodiment, this step can identify and transmit the known renumeration values extracted at step 130 with other information that may be relevant to the hiring and compensation determination process, including but not limited to, entity-specific information and normalized data from other entities in similar markets or with similar role titles and/or skill requirements. In this example, the known compensation values for an individual with a specific role within an entity can be extracted in step 130 and linked in step 140 with other information related to that individual's compensation. This other information may include, but is not limited to, the candidate data 442, position data 444, entity data 446, user data 448, module data 449, or any combination thereof (see FIG. 4). The linked data from step 140 may be stored in the data store 440, described in connection with FIG. 4, in one non-limiting embodiment.

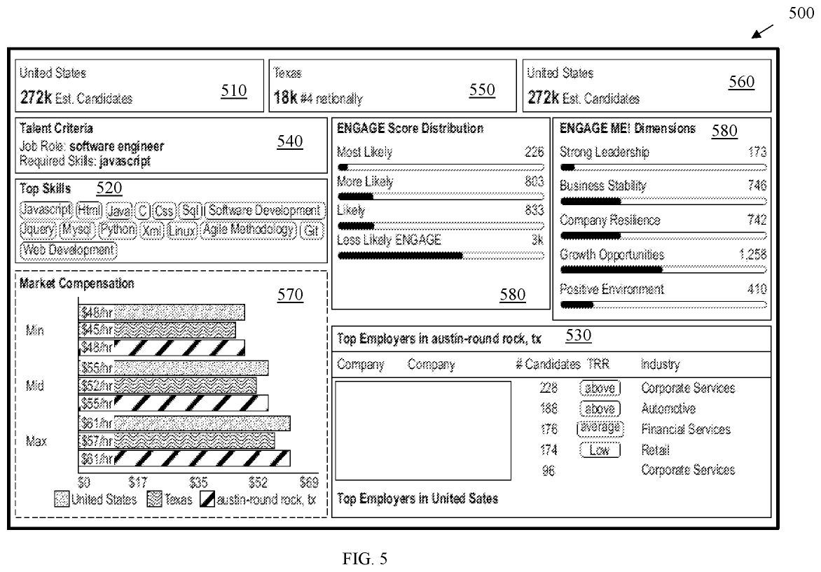

At step 150, the system creates (or retrieves from a database) a training dataset including the standardized position data element groups and known values that is used to iteratively train one or more raw training modules to create a trained training module. The system in step 160, can receive and process an input position data element set, and in step 170 can use the trained training module to identify, for a specific position, a display renumeration value to attract the appropriate person for a position based on a series of standardized position data element groups, including but not limited to: experience, skills, position title, geographic location, and competitor analytics. In step 180, the system modifies a display based on the display renumeration value, including but not limited to, interactive interface graphics as seen in FIGS. 5-7. As described below in connection with FIG. 4, the steps 150-180 may be performed by a module service 414 or a position service 412, or a combination of both.

Additionally, in some embodiments, the training module can be trained using the machine learning training system of the '263 application or the analysis engine described in U.S. patent application Ser. No. 16/549,849 filed Aug. 21, 2019, entitled “MACHINE LEARNING SYSTEMS FOR PREDICTIVE TARGETING AND ENGAGEMENT,” (“the '849 application”), which is incorporated herein by reference in its entirety. In one example, the system can be trained using a modification of Equation 1 and Equation 2 of the '263 application, wherein the modification includes a vector of characteristics for a position, including compensation, rather than just the candidate.

Also, the system can include one or more secondary metrics as parameters in one or more processes to iteratively train a training module or a plurality of training modules (as described herein). When used throughout the present disclosure, one skilled in the art will understand that processes for “iteratively training the training module” can include machine learning processes, artificial intelligence processes, and other similar advanced machine learning processes. For example, the system and processes of the present disclosure can calculate estimated renumeration demands for a plurality of positions and can leverage the calculated renumeration demands as an input to an iterative training process for identifying a display renumeration based on a plurality of tunable emphasis guidelines. When used throughout the present disclosure, one skilled in the art will understand that “emphasis guidelines” can include weights, ranks, or other similar factors or variables of varying levels of significance based on the specific metric being analyzed by the training module. For example, in some embodiments, the emphasis guidelines as described herein can include weights, ranks, or the like assigned to a plurality of connections between a plurality of nodes of a training module as described herein.

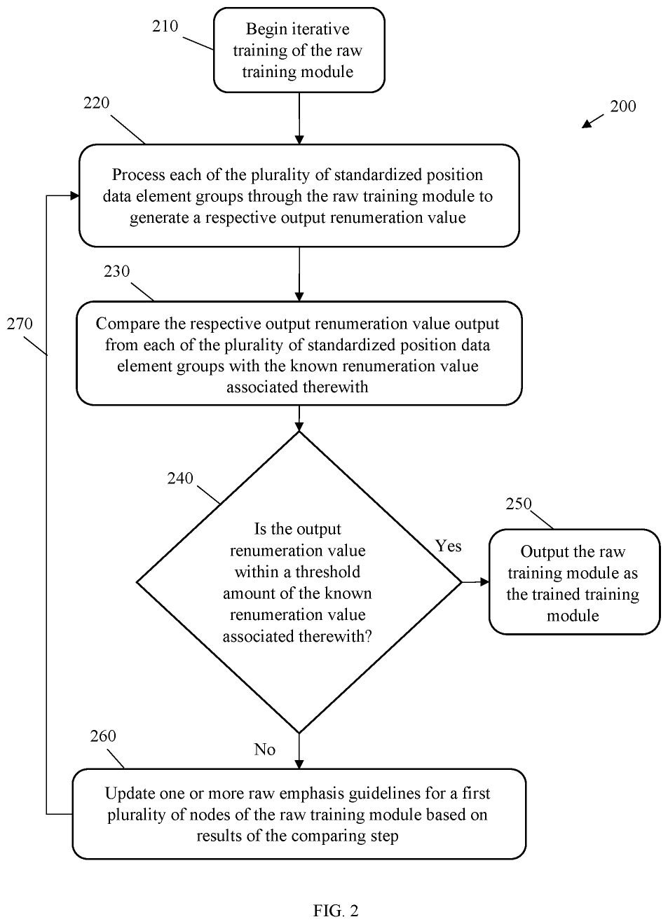

FIG. 2 illustrates a training process 200 for iteratively training the one or more raw training modules, as shown in step 150 of FIG. 1. At step 210, the system begins to iteratively train the one or more training modules. For example, the system can generate a first version of the training module. The first version training module, in step 220, can process each of the plurality of standardized position data element groups, using known parameters, to generate a set of training outcomes (e.g., respective output renumeration values). In one embodiment, the system may utilize the module service 414, described in connection with FIG. 4, to perform various data analysis and modeling processes, including the generation and training of the first version of the training module in step 210 and for generating a recommended renumeration value, including various components of a compensation package based on entity-specific factors in step 220.

At step 230, the system can compare the set of training outcomes from each of the plurality of standardized position data element groups to the training set of known rate values associated therewith and can calculate one or more error metrics between the respective output rate value and the known rate values. In at least one embodiment, the system may generate models, outcomes, predictions, and classifications for entities and industries using ensemble models that combine aggregate impacts of the roles and skillsets of the employees that make up each entity or industry as well as models that generate entity specific and industry specific scoring methodologies. In at least this way, the system creates the plurality of standardized position data element groups used to compare, at step 230, to the set of training outcomes. For example, the system may generate an aggregated model, outcomes, predictions, and classifications for teams of engineers at a particular entity. The aggregated model, outcomes, predictions, and classification may assist the entity in determining appropriate renumeration packages to offer new engineers being hired or provide appropriate compensation to existing team members in order to improve retention.

At step 240, the system determines if the output renumeration value falls within a preconfigured threshold amount of the known rate value associated therewith. In one example, if the training module determines a recommended renumeration value, or compensation package, for a Senior Level Software Engineer at Entity A, and that recommended renumeration value is above or below a threshold percentage of what Entity A is currently compensating a Senior Level Software Engineer, the system would identify this discrepancy at step 240 and make modifications to the one or more emphasis guidelines at step 260. Otherwise, if the recommended renumeration value is within the threshold percentage, the raw training module is updated according to step 250. In some embodiments, there may be multiple factors that contribute to the compensation of an individual, including but not limited to education, years of experience, location, etc. and the system can be retrained to analyze a plurality of the one or more emphasis guidelines in the retraining process to accommodate for these different factors, even if the system outputs a renumeration value within the preconfigured threshold amount.

If yes, at step 250, the system outputs or updates the raw training module as the trained training module. In one embodiment, the module service 414 can further be configured to generate, train, and execute neural networks, gradient boosting algorithms, mutual information classifiers, random forest classifications, and other machine learning and related algorithms in order to complete at least steps 230-350.

If no, at step 260, the system may update one or more raw emphasis guidelines for a first plurality of nodes of the raw training module, such that the raw emphasis guidelines are updated based on analysis of the comparing step 230. The system can iteratively retrain the raw training module by repeating the process 200 with the updated one or more emphasis guidelines. For example, if emphasis guidelines related to or associated with a specific skillset are significantly contributing to returning a recommended renumeration value below the standardized position data element groups for an individual with that specific skillset in that position, the system can increase or decrease the emphasis guideline related to that skillset and retrain the model. In another example, the system can update and retrain the raw training module based on adjusted emphasis guidelines related to a location, using market average standardized position data element groups and/or entity-specific data for a specific location or region, to recommend updated renumeration or compensation packages for employees relocating or being hired for a new location. Additional examples of the one or more emphasis guidelines are provided in connection with the description for FIG. 4.

The system can further be used to iteratively optimize the first version training module into one or more secondary version training modules by: 1) calculating and assigning an emphasis (e.g., weights) to each of the known standardized position data element groups (e.g., parameters or derivatives thereof); 2) generating one or more additional training modules that generate one or more additional sets of training module outcomes; 3) comparing the one or more additional sets of training module outcomes to the known outcomes; 4) re-calculating the one or more error metrics; 5) re-calculating and re-assigning emphasis to each of the emphasis guidelines to further minimize the one or more error metrics; 6) generating additional training modules and training module outcomes, and repeating the process. In at least one embodiment, the system can combine one or more raw training modules to generate a trained training module. The system can iteratively repeat steps 220-260, thereby continuously training and/or combining the one or more raw training modules until a particular training module demonstrates one or more error metrics below a predefined threshold or demonstrates an accuracy and/or precision at or above one or more predefined thresholds.

In various embodiments, the system may continuously and/or automatically monitor data sources for changes in position data and other information. In at least one embodiment, the system can be configured to monitor changes to the data sources by a plurality of data monitoring techniques, including but not limited to: web scraping, receiving push updates or notifications from a plurality of data sources, analyzing information and reports, or a combination of any of these. The system can be further configured to perform various data analysis, modifications, or normalizations to the various information in order to determine which information is new or has been changed compared to the information previously received or retrieved. In some embodiments, the position service 412, described in connection with FIG. 4, can be used to perform some or all of the steps of the data monitoring process. In at least one embodiment, upon detecting a change in position data or other information, the system may perform actions including, but not limited to, automatically collecting, storing, and organizing the updated position data or other information, generating and/or transmitting one or more notifications if preconfigured to indicate an update to the data. The updated data can also be used to retrain one or more training modules to generate updated recommendations, including the processes 100 and 200 described in connection with FIG. 1 and FIG. 2.

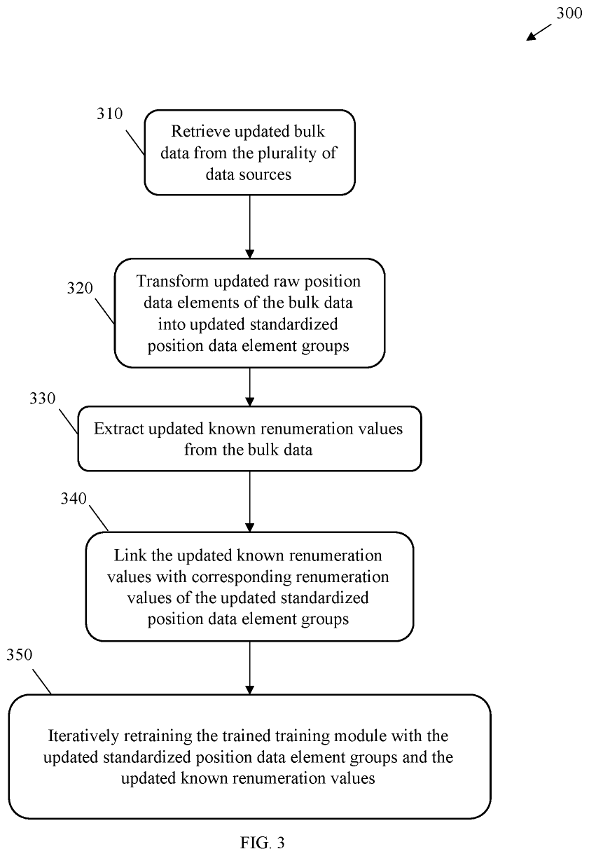

FIG. 3 illustrates a process 300 for updating the standardized position data elements to iteratively retrain the trained training modules when updated bulk data is available in the plurality of data sources. At step 310, the system retrieves updated bulk data from the plurality of data sources. Like the original bulk data described in connection with FIG. 1, the updated bulk data can include update raw position data elements. Once retrieved or collected, the updated bulk data may be stored in the databases or the data lake. According to various aspects of the present disclosure, the data may then be processed, cleaned, and mapped across the various data sources. For example, the system may update, at a database and for a particular position, existing information to include a classification assigned to a particular position. Additionally, the system may retrieve the bulk data updated by one or more of the plurality of databases to include updated position data or additional raw position data elements.

At step 320, the system transforms the updated raw data elements extracted in step 310, including a plurality of updated raw position data elements, into updated standardized position data element groups. Also at step 320, in at least one embodiment, prior to data transformation, the system can perform updated position resolution on the updated bulk data. In at least one embodiment, this step can identify and transmit the updated raw data elements extracted at step 310 with other information that may be relevant to the updated information, including but not limited to, entity-specific information if the update was result of a new position or a lateral hire. In this example, the known compensation values for an individual with a specific role within an entity can also be updated and extracted in step 310, as the result of a raise or demotion (for example), and linked in step 320 with other information related to that individual's compensation including a bonus or benefit or data related to time lapse since the last compensation update, for example. The updated raw position data elements can be further transformed into updated standardized position data element groups. To transform the updated raw positions data elements into updated standardized position data element groups, the system may assign updated classifications using a series of preconfigured keywords and metrics commonly found in the plurality of data sources to generate groups of updated standardized data element groups that can be further analyzed and processed during the iterative training step of 350. In one example, if an employee is laterally hired to a competitor entity, the data collected for that employee at the previous entity can be updated and associated with the new entity, and the standardized data element groups for both the old entity and the new entity can be updated appropriately to indicate this change and retrain the training module.

At step 330, the system extracts updated known renumeration values from the updated bulk data. The extraction may be performed through one or more data processing techniques described in connection with FIG. 1, including but not limited to, performing text recognition, data transformation, text mining, and information extraction.

In step 340, the system links the extracted updated known renumeration values with corresponding known renumeration values of the updated standardized position data element groups. The system may utilize some or all of the linking techniques described in connection with step 140, described in connection with FIG. 1, to complete step 340. In at least this way, the updated known renumeration values are associated with updated standardized position data element groups that are based on position-specific elements, and the extracted updated renumeration values may further be linked to a plurality of position-specific elements.

In one or more embodiments, the system can identify updated display renumeration values by evaluating and processing the updated data via one or more training modules. By iteratively retraining the trained training modules at step 350, the system is configured to process updated bulk data and associated updated position data elements to minimize error metrics between the training module outcomes and the known outcomes. In at least one embodiment, the system can combine one or more trained training modules to generate an updated trained training module. The system can iteratively repeat steps 310-350, thereby continuously training and/or combining the one or more trained training module until a particular training module demonstrates one or more error metrics below a predefined threshold or demonstrates an accuracy and/or precision at or above one or more predefined thresholds. In some embodiments, the iterative retraining of the trained training module at step 350 can include employing the iterative training process shown and described with respect to FIG. 2.

In one or more embodiments, the system can identify updated display renumeration values by evaluating and processing the updated data via one or more trained training modules. The system can modify the display based on the updated display renumeration value, including but not limited to, interactive interface graphics as seen in FIGS. 5-7.

FIG. 4 illustrates a networked environment or system 400 for use in generating the trained training module as described herein. In various embodiments, the networked environment 400 includes a recommendation system configured to perform one or more processes for advanced data processing and transforming data into customized recommendations for position-specific renumeration based on a plurality of emphasis guidelines. The networked environment 400 may include, but is not limited to, a computing environment 410, one or more data sources 420, and one or more computing devices 430 that communicate together over a network 450. The network 450 includes, for example, the Internet, intranets, extranets, wide area networks (“WANs”), local area networks (“LANs”), wired networks, wireless networks, or other suitable networks, or any combination of two or more such networks. For example, such networks can include satellite networks, cable networks, Ethernet networks, and other types of networks.

According to some embodiments, the computing environment 410 includes, but is not limited to, a position service 412, a module service 414, a rate service 416, and a data store 440. The elements of the computing environment 410 can be provided via a plurality of computing devices 430 that may be arranged, for example, in one or more server banks or computer banks or other arrangements. Such computing devices 430 can be located in a single installation or may be distributed among many different geographical locations. For example, the computing environment 410 can include a plurality of computing devices 430 that together may include a hosted computing resource, a grid computing resource, and/or any other distributed computing arrangement. In some cases, the computing environment 410 can correspond to an elastic computing resource where the allotted capacity of processing, network, storage, or other computing-related resources may vary over time.

In various embodiments, the data source 420 generally refers to internal or external systems, databases, or other platforms from which various data is received or collected. Non-limiting examples of data sources 420 include, but are not limited to, the proprietary and non-proprietary examples provided in the description of step 110 of FIG. 1. In another example, a data source 420 includes a site for posting available positions from which the computing environment 410 collects and/or receives position information. In another example, a data source 420 includes a geolocation service form which the computing environment 410 retrieves addresses and other location data.

The position service 412 can be configured to request, retrieve, and/or process data from data sources 420. In one example, the position service 412 is configured to automatically and periodically (e.g., daily, every 3 days, 2 weeks, etc.) collect position information from a plurality of databases including both open and filled positions. In another example, the position service 412 is configured to request and receive a list of required and preferred skills from either individual records or open position postings. In another example, the position service 412 can be configured to monitor for changes to various information at a data source 420. In one example, the position service 412 monitors for changes to position status or individual rate values. In this example, the position service 412 detects that position title or rate value associated with a particular individual has changed. Continuing this example, in response to the determination, the position service 412 automatically collects the new position information, which may be stored in the data store 440. The position service 412 can perform various data analysis, modifications, or transformation to the various information. The position service 412 can determine likely categories or bins for various data for each position. As an example, the position service 412 can determine that the “Software Development 3 at Company A” fits into a middle-level bin for job skill for the job title being a “3” of 5 level and is likely a full-time position based on title and entity information. Further, the position service 412 can determine that the “Freelance Coder” position may be of a software development category and that the skill level associated with the position may be indeterminate.

The module service 414 can be configured to perform various data analysis and modeling processes. In one example, the module service 414 generates and iteratively trains training modules for providing dynamic renumeration communications. For example, in some embodiments the module service 414 can be configured to perform one or more of the various steps of the processes 100, 200, and 300 shown and described in connection with FIGS. 1-3. The module service 414 can be configured to generate, train, and execute a plurality of nodes, neural networks, gradient boosting algorithms, mutual information classifiers, random forest classifications, and other machine learning and artificial intelligence related algorithms.

The module service 414 or position service 412 can be configured to perform various data processing and transformation techniques to generate input data for training module and other analytical processes. For example, in some embodiments the module service 414 or the position service 412 can be configured to perform one or more of the data processing and transformation steps of the processes 100, 200, and 300 shown and described in connection with FIGS. 1-3. Non-limiting examples of data processing techniques include, but are not limited to, entity resolution, imputation, and missing or null value removal. In one example, the module service 414 performs entity resolution on position data for a plurality of positions to standardize terms such as position titles, entity names, and locations. Entity resolution may generally include disambiguating manifestations of real-world entities in various records or mentions by linking and grouping. In one embodiment, a dataset of position data may include a plurality of positions for a single entity. In one or more embodiments, the system may perform entity resolution to identify data items that refer to the same entity but may use variations of the position's title. In a non-limiting example, a dataset may include references to a position title Software Developer 3; however, various dataset entries may refer to an equivalent or similar position using terms like engineer, programmer, coder, and qualifying words like advanced, experienced, intermediate, senior, and other variants. In a similar scenario, an embodiment of the system may perform entity resolution to identify all dataset entries that include a variation of the entity's name and replace the identified dataset entries with the standard entity name based on the industry. The module service 414 may utilize historical data for various entities to rate a likely skill level of the position that worked at the entity. As an example, the module service 414 may identify those future positions for individuals with previous experience at Entity A correlate with better future position titles than individuals with previous experience at Entity B. The module service 414 may adjust the skill level or qualifications of a position based on evaluations of other positions at a shared entity.

The rate service 416 can be configured to generate rate packages (e.g., rate packages including both pay and benefits). In one embodiment, the rate service 416 can be used to give entities personalized renumeration communications based on position, entity attributes, supply and demand of qualified individuals, geographic location, desired skillsets, competitors' Talent Retention Risk (“TRR”) Scores℠, and more. In at least one embodiment, the system may generate models, outcomes, predictions, and classifications for entities and industries using ensemble models that combine aggregate impacts of the candidates, positions, associated skillsets, compensation, and other factors that make up each entity or industry as well as models that generate entity specific and industry specific taxonomies. In one embodiment, the system may utilize and integrate with the TRR Score model system described in the '849 application. The system goes beyond average rates and identifies a renumeration value needed to attract the person they want for a specific position. In some embodiments, the rate service 416 can leverage training module processes (e.g., via the module service 414) to generate rates that are optimized to increase a likelihood of the rate attracting one or more individuals for a specific position. In some embodiments, the rate service 416 optimizes rate based on candidate data 442 with which a particular candidate is associated and/or position data 444 or entity data 446 with which a request is associated.

The data store 440 can store various data that is accessible to the various elements of the computing environment 410. In some embodiments, data (or a subset of data) stored in the data store 440 is accessible to the computing device 430 and one or more external system (e.g., on a secured and/or permissioned basis). Data stored at the data store 440 can include, but is not limited to, candidate data 442, position data 444, entity data 446, user data 448, and module data 449. The data store 440 can be representative of a plurality of data stores 440 as can be appreciated. The candidate data 442, the position data 444, and the entity data 446 include, at least, the information within the collected bulk data associated with each type of data as described in step 110 of FIG. 1.

The user data 448 can include information associated with one or more users. For example, for a particular user, the user data 448 can include, but is not limited to, an identifier, user credentials, and settings and preferences for controlling the look, feel, and function of various processes discussed herein. User credentials can include, for example, a username and password, biometric information, such as a facial or fingerprint image, or public/private keys. Settings can include, for example, communication mode settings, alert settings, schedules for performing iterative training of training modules and/or recommendation generation processes, and settings for controlling which of a plurality of potential data sources 420 are leveraged to perform training module processes.

In one example, the settings include standardized position data element groups for a particular position location or region. In this example, when the data inputs are filtered to a particular region, a training module output can be adjusted to provide more or less emphasis for a cost of living, culture, or other factors with which the particular region is associated. Various regions and sub-regions of the world may demonstrate varying cultures and expectations related to renumeration values. These variances may impact the emphasis of specific guidelines imposed on a plurality of nodes within the iterative training process for generating trained training modules in order to update the training module to output accurate and appropriate outcomes. For example, the system may alter one or more emphasis guidelines to reduce an impact or change impact directionality on renumeration communications. In the above example, the system may reduce emphasis guidelines on a plurality of nodes and/or modify emphasis guidelines on a plurality of nodes including the emphasis of specific skills, geographic location of an individual, or related positions, thereby modifying the guideline's emphasis and impact on subsequently generated recommendations as the training module is iteratively trained.

The module data 449 can include data associated with iteratively training of the training modules and other modeling processes described herein. Non-limiting examples of module data 449 include, but are not limited to, machine learning techniques, parameters, guidelines, emphasis values (e.g., weight values), input and output datasets, training datasets, validation sets, configuration properties, and other settings. In one example, module data 449 includes a training dataset including historical candidate data 442, position data 444, and entity data 446. In this example, the training dataset can be used for training a training module to provide a renumeration communication based on a specific position.

The computing device 430 can be any network-capable device including, but not limited to, smartphones, computers, smart accessories, such as a smart watch, key fobs, and other external devices. The computing device 430 can include a processor and memory. The computing device 430 can include a display 432 on which various user interfaces can be rendered by a position application 434 to configure, monitor, and control various functions of the networked environment 400. For example, in some embodiments the computing device 430 can be configured to perform one or more of the modifying display steps of the processes 100, 200, and 300 shown and described in connection with FIGS. 1-3. Additionally, the output display modified by the system in one or more steps of the processes 100, 200, and 300 can include the display interface illustrations 500, 600, and 700 for FIGS. 5-7, for example. The position application 434 can by executed on the computing device 430 and can display information associated with processes of the networked environment 400 and/or data stored thereby. In one example, the position application 434 displays position profiles that are generated or retrieved from user data 448.

The computing device 430 can include an input device 436 for providing inputs, such as requests and commands, to the computing device 430. The input device 436 can include one or more of a keyboard, mouse, pointer, touch screen, speaker for voice commands, camera or light sensing device to reach motions or gestures, or other input device 436. The position application 434 can process the inputs and transmit commands, requests, or responses to the computing environment 410 or one or more data sources 420. According to some embodiments, functionality of the position application 434 is determined based on a particular user or other user data 448 with which the computing device 430 is associated. In one example, a computing device 430 is associated with a user and the position application 434 is configured to display position profiles based on geographic location provide display renumeration and renumeration packages based on specific locations. A user can use the input device 436 to modify emphasis guidelines, for example to exclude certain required skills or to filter to a specific geographic region. The input from the input device 436 is transmitted or otherwise communicated with the computing environment 410 to update the display renumeration output, which is communicated to the computing device 430, which modifies the display 432 to include the updated recommendation based on the specific emphasis guidelines selected or deselected by the user. In at least this way, the system and process for training the training module of the present disclosure transforms raw position data elements to provide a customized recommendation that can be further modified and adjusted based on position-specific emphasis guidelines and user input.

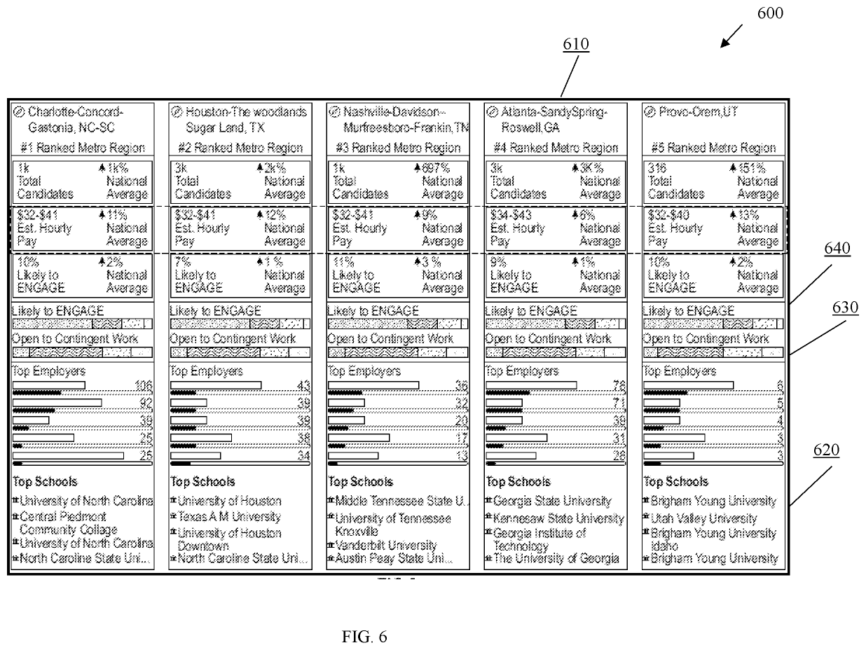

FIG. 5 illustrates a display interface 500 that may be generated on a display 432 and updated by the system and processes described in the present disclosure. The interface may include, but is not limited to, customized outcomes as processed and analyzed by the trained training modules of the described system. The interface can include statistical information measured from the raw position data elements, including but not limited to: number of positions or individuals evaluated 510, top skills 520, and top employers 530 based on quantified raw data elements retrieved and processed by the system. These metrics, and others shown on the interface can be updated and customized based on the emphasis guidelines and user input for position-specific guidelines 540. For example, the display interface 500 shows the number of estimated candidates in Texas 550, as compared to nationally 560. This metric can be updated based on a different geographic region by modifying emphasis guidelines related to other locations. Additionally, the top skills 520 identified on the display interface 500 may be updated as the training system is updated in accordance with user input or updated bulk data collected as described in the process 300. Additionally, the display interface 500 provides a graphical depiction of rate 570 based on location compared to national averages and can automatically update according to adjusting the emphasis guidelines related to location or position level, as an example. In one embodiment, the system identifies the most in-demand and expensive skills and experience for specific roles. With skill-level rate filtering, entities can see in real time how suggested rates shift with changing skillset preferences and requirements. The system is also configured to provide a display renumeration that identifies how much below or above the average rate in a given location the entity should provide to attract an individual. In at least this way, the data collected by the bulk data sources is transformed into raw position data elements that are processed and analyzed by iteratively trained training modules to provide customized and dynamic output renumeration communications. The display interface 500 can further include a plurality of “ENGAGE” metrics 580 related to how more or less likely a specific individual in a specific position, or similar position, is likely to engage with an entity for a new position, and therefore can provide a measure of how likely an individual is to be attracted by the display renumeration package. The plurality of “ENGAGE” metrics 570 and 640 (described in connection with FIG. 6 below) may be predicted using the system and training models described in the '849 application.

FIG. 6 is an illustration of a display interface 600 that may be generated on a display device such as the display 432 and updated by the system and processes described in the present disclosure. The display interface 600 may include, but is not limited to, customized outcomes as processed and analyzed by the trained training modules of the described system. The interface 600 can include comparison information for a specific position across multiple geographic locations 610. The display interface 600 can be customized and updated similarly to the display interface 500 but provides additional information including the top schools 620 in each geographic region 610 and information related to how likely candidates in each region are likely to be open to contingent work 630 as compared to the national average and “ENGAGE” with a new position 640 as compared to the national average. It will be recognized by one skilled in the art that the display interface 600 contains a plurality of customized outcomes although only one callout for each feature may be represented in FIG. 6 for clarity.

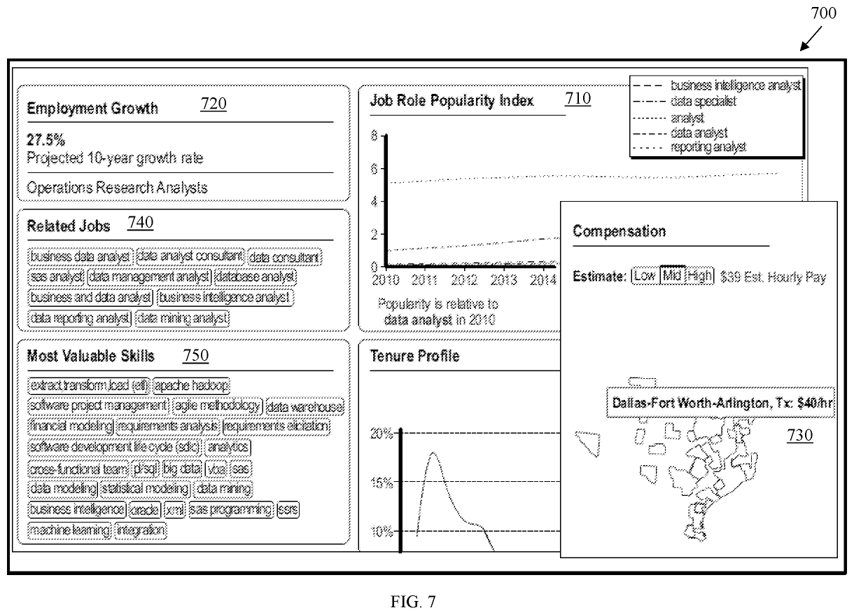

FIG. 7 is an illustration of a display interface 700 that may be generated on a display device such as the display 432 and updated by the system and processes described in the present disclosure. The display interface 700 may include, but is not limited to, dynamic research analysis metrics based on outcomes of the trained training module processes described herein. For example, the display interface 700 includes a comparison of position popularity 710 based on related position and a predicted Employment Growth 720 for a specific geographic location 730. Additionally, this display interface 700 (as well as the display interface 500 and display interface 600) may be configured to receive inputs by the user using an input device 436 to add/remove/edit emphasis guidelines, including at least “Related Jobs” 740 and “Most Valuable Skills” 750. Once a user has edited the metrics output by the training system on the display interface 700, the system and processes described in the present disclosure can automatically update the display renumeration value and associated research analysis metrics according to the updated training module outcomes.

It will be understood that various aspects of the processes described herein are software processes that execute on computer systems that form parts of the system. Accordingly, it will be understood that various embodiments of the system described herein are generally implemented as specially configured computers including various computer hardware components and, in many cases, significant additional features as compared to conventional or known computers, processes, or the like, as discussed in greater detail herein. Embodiments within the scope of the present disclosure also include computer-readable media for carrying or having computer executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (“SSDs”) or other data storage devices, any type of removable non-volatile memories such as secure digital (“SD”), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network 450 or another communications connection (either hardwired, wireless, or a combination of hardwired or wireless) to a computer, the computer properly views the connection as a computer readable medium. Thus, any such connection is properly termed and considered a computer-readable medium. Combinations of the above should also be included within the scope of computer-readable media. Computer-executable instructions comprise, for example, instructions and data which cause a general-purpose computer, special purpose computer, or special purpose processing device such as a mobile device processor to perform one specific function or a group of functions.

Those skilled in the art will understand the features and aspects of a suitable computing environment 410 in which aspects of the disclosure may be implemented. Although not required, some of the embodiments of the claimed systems may be described in the context of computer-executable instructions, such as program modules or engines, as described earlier, being executed by computers in networked environments 400. Such program modules are often reflected and illustrated by flow charts, sequence diagrams, screen displays, and other techniques used by those skilled in the art to communicate how to make and use such computer program modules. Generally, program modules include routines, programs, functions, objects, components, data structures, API calls to other computers whether local or remote, etc. that perform particular tasks or implement particular defined data types, within the computer. Computer-executable instructions, associated data structures and/or schemas, and program modules represent examples of the program code for executing steps of the processes disclosed herein. The particular sequence of such executable instructions or associated data structures represents examples of corresponding acts for implementing the functions described in such steps.

Those skilled in the art will also appreciate that the claimed and/or described systems and processes may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

A system for implementing various aspects of the described operations, which is not illustrated in detail, includes a computing device 430 including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

As will be understood from discussions herein, the present systems and processes may leverage iterative training modules and other advanced/innovative computing techniques to provide an optimized renumeration value for a specific position within a particular entity. In at least one embodiment, the system may provide an optimized renumeration value for a specific position as an output of an iterative computing process based at least in part on location of the position, market renumeration packages based on similar positions, and data and/or parameters specifically associated with the entity looking to fill the position (and/or retain talent in particular positions).

The present systems and processes represent an improvement over existing systems and technology. In particular, the present systems and processes are an improvement over existing computing systems for the following non-limiting reasons: 1) the present systems and processes are an improvement over prior systems and processes that may merely compare publicly available data or do not iteratively train modules/models to determine particular renumeration packages; and 2) the present systems and processes improve upon prior systems by leveraging entity-specific data and assigning emphasis guidelines based on the same, thereby producing more entity-specific renumeration packages more quickly and potentially reducing computing power and processing time to potentially arrive at the same or similar results (e.g., other systems may require more training on publicly available data to get optimized renumeration packages and may never reach the level of accuracy of the present systems and processes).

In addition, the present systems and processes represent an improvement to creating renumeration packages generally. In particular, leveraging entity-specific data (e.g., an entity's specific brand/market position, opportunities, etc.) is an improvement over systems and processes that leverage publicly available (e.g., non-entity-specific data) to produce renumeration packages. Further, the present systems and processes generate renumeration packages customized to entity-specific factors and can be updated based on user-generated inputs/edits to a plurality of factors.

As will be understood from discussions herein, the present systems and processes may output information and data in addition to renumeration packages. The renumeration packages may include additional employee benefits, other than just a salary, and the system may also output other position-specific factors for the hiring team to consider when extending an offer. The other position-specific factors may include, but are not limited to, stipends, contingent work, flexible working arrangements, remote work, additional education opportunities, etc. In one embodiment, the system may be configured to output a particular renumeration package, along with other entity, location, or position-specific data produced from other iterative processes as shown in FIGS. 5-7 and discussed in relation to the same. In some embodiments, the system may output one or more factors or parameters that received the highest emphasis guidelines. In this embodiment (and others), the system outputs a listing of the highest weighted emphasis guidelines for a particular position (e.g., location, a particular skill, etc.) that produced a corresponding optimized renumeration package.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices 436, such as a microphone, etc. These and other input devices 436 are often connected to the processing unit through known electrical, optical, or wireless connections.

The computer that effects many aspects of the described processes will typically operate in a networked environment 400 using logical connections to one or more remote computers or data sources, which are described further below. Remote computers may be another personal computer, a server, a router, a network PC, a peer device, or other common network node, and typically include many or all of the elements described above relative to the main computer system in which the systems are embodied. The logical connections between computers include a LAN, a WAN, virtual networks (WAN or LAN), and wireless LAN (“WLAN”) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the WAN, such as the Internet. In a networked environment, program modules depicted relative to the computer, or portions thereof, may be stored in a remote data storage device. It will be appreciated that the network 450 connections described or shown are non-limiting examples and other mechanisms of establishing communications over WAN or the Internet may be used.

Additional aspects, features, and processes of the claimed systems will be readily discernible from the description herein, by those of ordinary skill in the art. Many embodiments and adaptations of the disclosure and claimed systems other than those herein described, as well as many variations, modifications, and equivalent arrangements and processes, will be apparent from or reasonably suggested by the disclosure and the description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and processes for using the same will become apparent from the information disclosed in the exhibits and the other applications as incorporated by reference. Variations and modifications to the disclosed systems and processes may be affected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The description of the disclosed embodiments has been presented only for the purposes of illustration and description and is not intended to be exhaustive or to limit the devices and processes for using the same to the precise forms disclosed. Many modifications and variations are possible in light of the above teaching.

The embodiments were chosen and described in order to explain the principles of the devices and processes for using the same and their practical application so as to enable others skilled in the art to utilize the devices and processes for using the same and various embodiments and with various modifications as are suited to the particular use contemplated. Alternative embodiments will become apparent to those skilled in the art to which the present devices and processes for using the same pertain without departing from their spirit and scope. Accordingly, the scope of the present devices and processes for using the same is defined by the appended claims rather than the description and the embodiments described therein.

What is claimed is:

1. A process for iteratively training a training module, the process comprising:
retrieving bulk data from a plurality of data sources, the bulk data comprising a plurality of grouped data entries that each include a respective known renumeration value and a respective plurality of raw position data elements;
transforming the respective plurality of raw position data elements in each of the plurality of grouped data entries according to preconfigured classification guidelines to generate a plurality of standardized position data element groups;
extracting the respective known renumeration value from each of the plurality of grouped data entries;
linking the known renumeration value extracted from each of the plurality of grouped data entries with a corresponding one of the plurality of standardized position data element groups;
training a raw training module by:
processing each of the plurality of standardized position data element groups through the raw training module to generate a respective output renumeration value;
comparing the respective output renumeration value output from each of the plurality of standardized position data element groups with the known renumeration value associated therewith; and
updating one or more raw emphasis guidelines for a first plurality of nodes of the raw training module based on results of the comparing step;
generating a trained training module by iteratively repeating the training of the raw training module until the results of the comparing step indicate that the respective output renumeration value output from each of the plurality of standardized position data element groups is within a threshold amount of the known renumeration value associated therewith;
receiving an input position data element set;
processing the input position data element set with the trained training module to generate a display renumeration value; and
modifying a display based on the display renumeration value.

2. The process for iteratively training the training module of claim 1 further comprising:
extracting one or more trained emphasis guidelines for a second plurality of nodes of the trained training module; and
modifying the display to include the one or more trained emphasis guidelines along with the display renumeration value.

3. The process for iteratively training the training module of claim 1 further comprising:
retrieving updated bulk data from the plurality of data sources, the updated bulk data comprising an updated plurality of grouped data entries that each include a respective updated known renumeration value and a respective updated plurality of raw position data elements;
transforming the respective updated plurality of raw position data elements in each of the updated plurality of grouped data entries according to the preconfigured classification guidelines to generate an updated plurality of standardized position data element groups;
extracting the respective updated known renumeration value from each of the updated plurality of grouped data entries;
linking the updated known renumeration value extracted from each of the updated plurality of grouped data entries with a corresponding one of the updated plurality of standardized position data element groups;
retraining the trained training module by iteratively:
processing each of the updated plurality of standardized position data element groups through the trained training module to generate the respective output renumeration value;
comparing the respective output renumeration value output from each of the updated plurality of standardized position data element groups with the updated known renumeration value associated therewith; and
updating one or more trained emphasis guidelines for a second plurality of nodes of the trained training module based on results of the comparing step.

4. The process for iteratively training the training module of claim 1 further comprising:
retrieving the bulk data from the plurality of data sources by retrieving proprietary bulk data from proprietary ones of the plurality of data sources and non-proprietary bulk data from non-proprietary ones of the plurality of data sources.

5. The process for iteratively training the training module of claim 1 further comprising:
after modifying the display, receiving changes to the input position data element set;
processing the changes to the input position data element set with the trained training module to generate an updated display renumeration value; and
modifying the display based on the updated display renumeration value.

6. The process for iteratively training the training module of claim 1 wherein each element in each one of the plurality of standardized position data element groups corresponds to one of the first plurality of nodes of the of the raw training module.

7. The process for iteratively training the training module of claim 1 wherein one element in each one of the plurality of standardized position data element groups includes a location element.

8. The process for iteratively training the training module of claim 1 wherein one element in each one of the plurality of standardized position data element groups includes a related entity element.

9. The process for iteratively training the training module of claim 1 further comprising:
in response to generating the display renumeration value, extracting one or more trained emphasis guidelines for a second plurality of nodes of the trained training module and generating a graphical user interface display that includes the display renumeration value and the one or more trained emphasis guidelines for the second plurality of nodes in relation to corresponding ones of the input position data element set.

10. The process for iteratively training the training module of claim 9 further comprising:
receiving user input via the graphical user interface display modifying the input position data element set;
processing the input position data element set as modified with the trained training module to generate an updated display renumeration value; and
generating the updated display renumeration value on the graphical user interface display.

11. A system for iteratively training a training module, the system comprising:
at least one memory unit;
at least one processor in communication with the at least one memory unit and at least one database, the at least one processor configured to:
retrieve bulk data from the at least one database;
process the bulk data by categorizing a plurality of grouped data entries that each include a respective known renumeration value and a respective plurality of raw position data elements;
transform the respective plurality of raw position data elements in each of the plurality of grouped data entries according to preconfigured classification guidelines to generate a plurality of standardized position data element groups;
extract the respective known renumeration value from each of the plurality of grouped data entries;
save the known renumeration value extracted from each of the plurality of grouped data entries in the at least one memory unit;
link the known renumeration value saved in the at least one memory unit with a corresponding one of the plurality of standardized position data element groups;
execute a raw training module by:
processing each of the plurality of standardized position data element groups through the raw training module to generate a respective output renumeration value;
storing the respective output renumeration value in the at least one memory unit;
comparing the respective output renumeration value saved in the at least one memory unit with the known renumeration value saved in the at least one memory unit and associated therewith;
updating one or more raw emphasis guidelines for a first plurality of nodes of the raw training module based on results of the comparing step; and
storing the updated one or more raw emphasis guidelines in the at least one memory unit;
generate a trained training module by iteratively repeating the execution of the raw training module until the results of the comparing step indicate that the respective output renumeration value saved in the at least one memory unit is within a threshold amount of the known renumeration value saved in the at least one memory unit and associated therewith;
receive an input position data element set;
process the input position data element set with the trained training module to generate a display renumeration value; and
modify a display based on the display renumeration value.

12. The system for iteratively training the training module of claim 11, wherein the at least one processor is further configured to:
extract one or more trained emphasis guidelines for a second plurality of nodes of the trained training module; and
modify the display to include the one or more trained emphasis guidelines along with the display renumeration value.

13. The system for iteratively training the training module of claim 11, wherein the at least one processor is further configured to:
retrieve updated bulk data from the at least one database;
process the updated bulk data by categorizing an updated plurality of grouped data entries that each include a respective updated known renumeration value and a respective updated plurality of raw position data elements;
transform the respective updated plurality of raw position data elements in each of the updated plurality of grouped data entries according to the preconfigured classification guidelines to generate an updated plurality of standardized position data element groups;
extract the respective updated known renumeration value from each of the updated plurality of grouped data entries;
save the updated known renumeration value extracted from each of the plurality of grouped data entries in the at least one memory unit;
link the updated known renumeration value saved in at least one memory unit extracted with a corresponding one of the updated plurality of standardized position data element groups;
retrain the trained training module by iteratively:
processing each of the updated plurality of standardized position data element groups through the trained training module to generate the respective output renumeration value;
storing the respective output renumeration value in the at least one memory units;
comparing the respective output renumeration value saved in the at least one memory unit with the updated plurality of standardized position data element groups associated therewith;
updating one or more trained emphasis guidelines for a second plurality of nodes of the trained training module based on results of the comparing step; and
storing the updated one or more trained emphasis guidelines in the at least one memory unit.

14. The system for iteratively training the training module of claim 11, wherein the at least one database includes at least one proprietary data source and at least one non-proprietary, and
wherein the at least one processor is further configured to:
retrieve proprietary segments of the bulk data from the at least one proprietary data source; and
retrieve non-proprietary segments of the bulk data from the at least one non-proprietary data source.

15. The system for iteratively training the training module of claim 11, wherein the processor is further configured to:
after modifying the display, receive changes to the input position data element set;
process the changes to the input position data element set with the trained training module to generate an updated display renumeration value;
save the updated display renumeration value in the at least one memory unit; and
modify the display based on the updated display renumeration value.

16. The system for iteratively training the training module of claim 11, wherein each element in each one of the plurality of standardized position data element groups corresponds to one of the first plurality of nodes of the of the raw training module.

17. The system for iteratively training the training module of claim 11, wherein one element in each one of the plurality of standardized position data element groups includes a location element.

18. The system for iteratively training the training module of claim 11, wherein one element in each one of the plurality of standardized position data element groups includes a related entity element.

19. The system for iteratively training the training module of claim 11, wherein the at least one processor is further configured to:
in response to generating the display renumeration value, extract one or more trained emphasis guidelines for a second plurality of nodes of the trained training module and generate a graphical user interface display for rendering, wherein the graphical user interface display includes the display renumeration value and the one or more trained emphasis guidelines for the second plurality of nodes in relation to corresponding ones of the input position data element set.

20. The system for iteratively training the training module of claim 19, wherein the at least one processor is further configured to:
receive a user input via the graphical user interface display;
update the input position data element set according to the user input;
process the input position data element set as updated with the trained training module to generate an updated display renumeration value;
save the updated display renumeration value in the at least one memory unit; and
generate an updated graphical user interface display for rendering, wherein the updated graphical user interface display includes the updated display renumeration value.
